(19) United States
(12) Patent Application Publication
(10) Pub. No.: US 2006/0118679 A1
(43) Pub. Date: Jun. 8, 2006

(54) Wrist supports

(76) Inventors: Ricardo Delgado, Garden Grove, CA (US); Gary D. Delgado, New York, NY (US); Boyd Willat, Los Angeles, CA (US)

Correspondence Address: GOTTLIEB RACKMAN & REISMAN PC, 270 MADISON AVENUE, 8TH FLOOR, NEW YORK, NY, 100160601, US

(21) Appl. No.: 11/274,599

(22) Filed: Nov. 14, 2005

Related U.S. Application Data
(60) Provisional application No. 60/627,498, filed on Nov. 12, 2004.

(51) Int. Cl. B68G 5/00

(52) U.S. Cl. 248/118

(57) ABSTRACT

A wrist support comprises a glide member, comfort support and attachment means for attaching the wrist support to a wrist of a user. In a preferred embodiment, the glide member has a curved bottom surface which provides unrestrained rolling movement on a surface upon which the device is used. The comfort support is preferably soft yet supportive of a user's wrist and includes pillowed elements on the edges of the comfort support. The pillowed elements form a space disposed beneath the carpal tunnel region of a user's wrist to provide for reduced pressure in that area. The attachment means comprises a plurality of flexible projections that surround a majority of the user's wrist.

This application claims the priority date of U.S. provisional patent application Ser. No. 60/627,498 filed on Nov. 12, 2004 which is hereby incorporated herein by reference.

### FIELD OF INVENTION

This invention relates to improvements in the field of wrist supports. More specifically, this invention involves wrist support devices for individuals who routinely engage in activities that involve repetitive movements of the wrist and hands such as directing a computer mouse and typing.

### BACKGROUND OF THE INVENTION

As increased amounts of work, education and recreation incorporate the use of computers, repetitive strain and stress injuries to the hands, wrists and arms and related conditions, such as carpal tunnel syndrome, become more prevalent. Generally, these injuries result from the use of computer mice and keyboards and often occur from repeated physical movements, damaging tendons, nerves, muscles and other soft body tissues. These injuries present a serious and very painful condition that is far easier to prevent than to cure once onset occurs, and can crop up even in young, physically fit individuals. Often times, these injuries cause people to leave computer dependent careers, or even to be disabled and unable to perform mundane tasks which are generally taken for granted.

Many support devices are commercially available to alleviate or prevent injuries associated with repetitive stress and strain to the wrist area. In particular, wrist rests and supports used in conjunction with keyboards and computer mice are widely available, whereon a user's wrists rest on a soft elongated pad which provides support while redirecting pressure points in the area. Devices of this type are further designed with the structure for keeping the wrist in a given position at all times in order to prevent injury while using a personal computer and other desktop devices.

Despite some of the advantages offered by these products, conventional wrist rests have certain shortcomings. For instance, prior art wrist supports are not capable of being customized to a desired height relative to the keyboard or mouse adjacent to which it is positioned. The lack of customization often prevents the effective positioning of a hand and wrist for purposes of using a mouse and typing thus making it harder for individuals to work effectively without pain, discomfort and the prospect of enduring a repetitive stress injury. Further, individuals with relatively smaller or larger hands and fingers find it particularly difficult, uncomfortable and inefficient to rest their hands on a standard wrist rest in the course of using a mouse or typing since they have difficulty positioning and repositioning repeatedly their hands effectively when laying their hands on these types of conventional support devices. Prior wrist supports also prevent micromovements when the full weight of the hand, wrist and arm rest on these supports. These drawbacks inevitably force users to refrain from fully releasing the full weight of their arms and hands on the rest and thus utilizing and taking advantage of the wrist rest or, in many cases, simply cause users to abandon use of the wrist rest entirely.

Further, prior art wrist supports are generally designed to rest in a stationary position, preventing them from freely moving with the wrist of a user along a surface. For example, computer mouse wrist supports, which may be formed as an integral section of a conventional mouse pad, are often intended to rest in a single fixed position once in use. The support section, much like a conventional keyboard wrist support, does not provide for any significant movement since the padded area is secured in a single position and the material comprising the bottom of the support produces friction between the material and surface upon which it is resting and prevents movement along a surface without the application of a significant amount of force.

Additionally, in the context of wrist supports which are capable of limited movement, these supports fail to provide users with a wide range of motion that is natural to a user. For example, when assuming a more relaxed position the hand and wrist of a user may tend to roll outwardly. Conventional wrist supports are not capable of this type of movement and may bias the wrist against such movement. Also, the hand and wrist of a user may tend to assume other physical positions that are comfortable to the user but which are not possible to attain with conventional supports that are not capable of particular movements such as rolling inwardly, outwardly, front to back and combinations thereof.

Likewise, computer mouse and keyboard wrist supports that are capable of limited movement along a surface, lack the means for attaching to the wrist of a user. Thus, for example, if a user must lift his hands to move them to a different area on the desk, the wrist support simply remains in place, obliging the user to manually lift the support and place it on another area of the desk.

### SUMMARY OF THE INVENTION

Accordingly, it is an object of the present invention to provide an improved wrist support device that reduces tension and pain to the carpal tunnel region of the wrist.

It is a another object of the present invention to provide a wrist support device that may be customized to a desired height relative to the keyboard or mouse adjacent to which it is positioned.

It is a further object of the present invention to provide a wrist support device that has a wide range of motion that is natural to a user, allowing a user's wrist to assume positions that were not achievable with conventional wrist supports.

It is yet another object of the present invention to provide a wrist support device that is selectively attachable to the wrist of a user.

It is still another object of the present invention to provide a wrist support device that facilitates micromovements of the wrist and hand area of a user.

Additional objectives will be apparent from the description of the invention that follows.

In its broadest aspects, the inventive wrist support comprises features beyond those found in prior art wrist supports, thereby providing a greater degree of effectiveness and versatility to users. A preferred embodiment of the wrist support comprises a glide member, a comfort support and attachment means for selectively attaching the device to the wrist of a user. The glide member or head is preferably made of polyurethane, hard plastic, Teflon coated or other similarly performing materials which provide for reduced friction between the glide member and a desktop or surface upon which the device is utilized.

The comfort support may comprise many different types of materials which are capable of providing support to the wrist of a user yet are soft and comfortable such as conventional gel pads, specialized pads incorporating displaceable gel, foam, rubber or other soft materials. The comfort support is preferably curvilinear, however, the dimensions may vary as desired and can be configured in a number of shapes and degrees of thickness. Significantly, the comfort support preferably includes a plurality of pillow elements which are spaced apart to provide for a gap or space directly below the carpal tunnel region of the wrist so that no pressure or at least a reduced amount of pressure is placed against the wrist in that area.

In a preferred embodiment, the attachment means selectively maintains the device around the wrist of a user and comprises at least one projection extending upwardly from the glide member. Optionally, the projection does not proceed entirely around a user's wrist, but in conjunction with said comfort support surrounds approximately 300 degrees of the wrist. Other attachment means comprise a strap and/or hook and loop fasteners which are utilized independently or in conjunction with the projection extending from the glide member.

### BRIEF DESCRIPTIONS OF THE DRAWINGS

With reference to the figures,

FIG. 1 is a perspective view of a preferred embodiment of the wrist support of the present invention, with a user's hand shown in dashed lines for environmental purposes;

FIG. 2 is a cross sectional view of the wrist support taken along line 2-2 of FIG. 1;

FIG. 2A is a cross sectional view of the wrist support taken along line 2A-2A of FIG. 1;

FIG. 3A is a bottom view of the first preferred embodiment of the glide member of the wrist support shown in FIG. 1;

FIG. 3B is a bottom view of a second preferred embodiment of the glide member of the wrist support shown in FIG. 1;

FIG. 3C is a cross sectional view of the second embodiment of the glide member taken along line 3C-3C of FIG. 3B;

FIG. 3D is a cross sectional view of a third embodiment of the glide member comprising rolling bearings disposed within a cavity;

FIG. 4 is a cross sectional view a second embodiment of the wrist support of the present invention, with the glide member comprising a threaded insertion for adjusting the height of the device and wrist of a user;

FIG. 5 is a cross sectional view of the embodiment shown in FIG. 4, with the glide member in the extended position;

FIG. 6 is a perspective view of a third embodiment of the wrist support of the present invention, with the comfort support disengaged from the open interior frame;

FIG. 7 is a perspective view of the embodiment shown in FIG. 6 with the comfort support positioned in the closed interior frame;

FIG. 8 is a cross sectional view of the wrist support taken along line 8-8 of FIG. 7.

FIG. 9 is a perspective view of a fourth and laterally positioned embodiment of the wrist support of the present invention;

FIG. 10 is a cross sectional view of the wrist support taken along line 10-10 of FIG. 9;

FIG. 11 is a perspective view of a fifth embodiment of the wrist support of the present invention;

FIG. 11A is a cross sectional view of the wrist support taken along line 11A-11A of FIG. 11;

FIG. 12 is a perspective view of a sixth embodiment of the wrist support of the present invention;

FIG. 13 is a cross sectional view of the wrist support taken along line 13-13 of FIG. 12;

FIG. 14 is a cross sectional view of a seventh embodiment of the wrist support of the present invention with an inflatable air bladder incorporated therein between the glide member and the comfort support;

FIG. 15 is a cross sectional view of the wrist support shown in FIG. 14 with the inflatable air bladder in the inflated position;

FIG. 16 is a perspective view of an eighth embodiment of the wrist support of the present invention with an inflatable air bladder incorporated therein;

FIG. 17 is an elevational view of the wrist support shown in FIG. 16 with the inflatable air bladder in the inflated position;

FIG. 18 is a cross sectional view of the wrist support taken along line 18-18 of FIG. 16 depicting an inflatable air bladder;

FIG. 19 is a perspective view of a ninth embodiment of the wrist support of the present invention;

FIG. 20 is a cross sectional view of the wrist support taken along line 20-20 of FIG. 19 depicting an inflatable air bladder with a baffled chamber;

FIG. 21 is a perspective view of a tenth embodiment of the wrist support of the present invention;

FIG. 22 is a perspective view of an eleventh embodiment of the wrist support of the present invention;

FIG. 23 is a perspective view of a twelfth embodiment of the wrist support of the present invention; and

FIG. 24 is a perspective view of a thirteenth embodiment of the wrist support of the present invention.

### DETAILED DESCRIPTION OF THE INVENTION

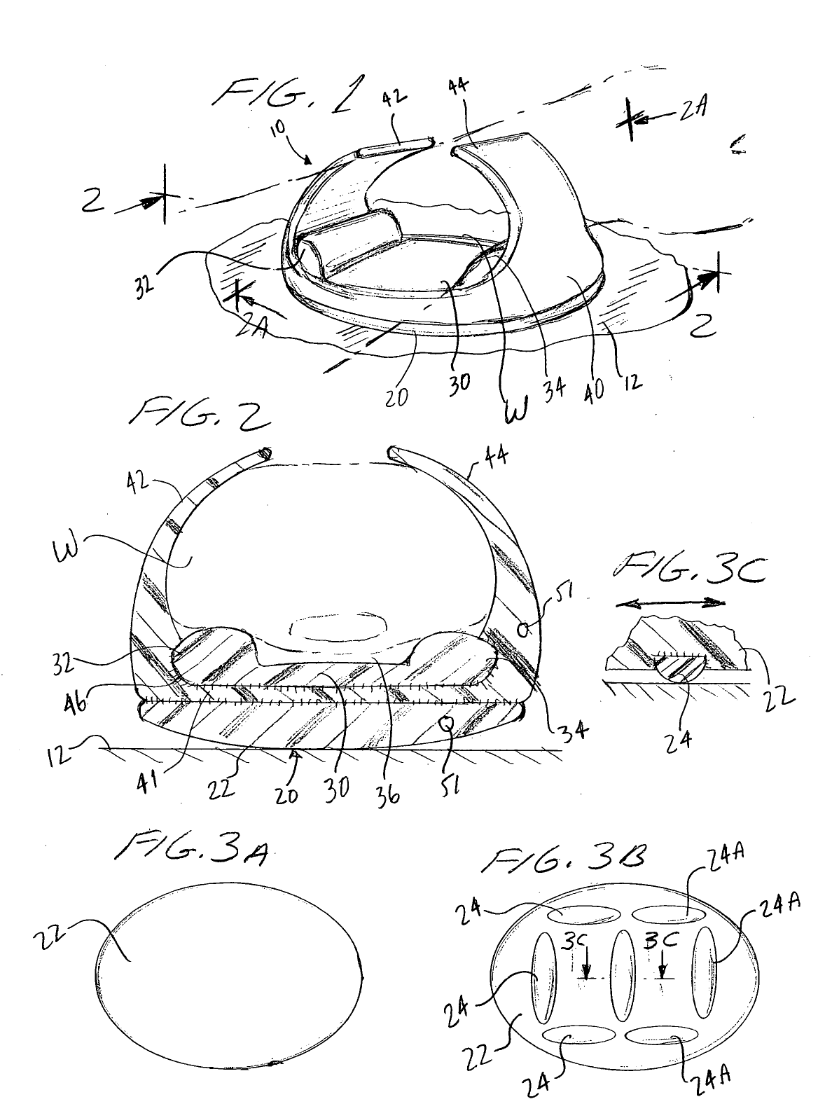

Referring to a preferred embodiment of the present invention, there is shown in FIGS. 1 and 2 a wrist support 10 comprising a glide member or head 20, comfort support 30 and frame 40 with a flat bottom wall 41 with upwardly-extending opposed and inwardly-curved projections 42, 44 emanating from the lateral edges of the frame 40 and integrally molded thereto. The projections 42, 44 are structured to gently grip the wrist area W of a user

As shown in FIGS. 1, 2, 2A and 3A, the glide member 20 comprises a smooth, semi-spherical or domed bottom surface 22. Optionally, the bottom may be a flat planar surface instead of the domed bottom surface 22 shown in FIGS. 1, 2, 2A and 3A. Generally, employing a domed bottom instead of a flat surface provides for an increased range of motion while wearing the wrist support 10. For example, with a domed bottom surface 22, users can roll the wrist support 10 to the right or left, forward or backward, and combinations thereof, providing for unrestrained rolling movement of the wrist support 10 during use.

Preferably, the glide member 22 comprises polyurethane, Teflon coated material, hard plastic or other known substances which produce a reduced amount of friction between the bottom surface 22 of the glide member 20 and the surface 12 upon which the wrist support 10 is utilized, thereby limiting the drag of the wrist support 10 during use. The glide member 20 is also constructed of non-abrasive materials at the bottom surface 22 thereby minimizing scratching, wear or other forms of damage to the surface 12.

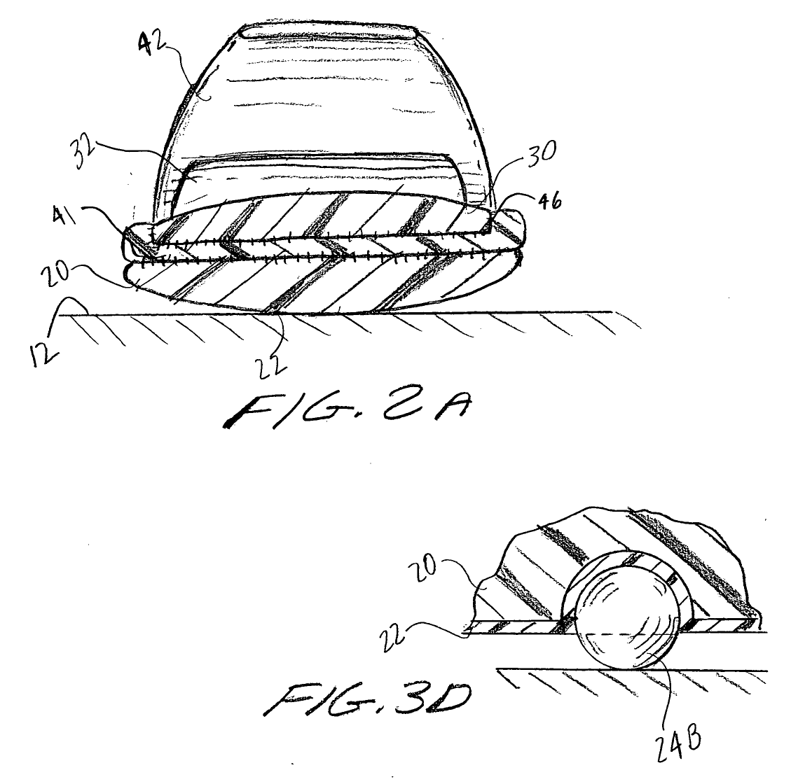

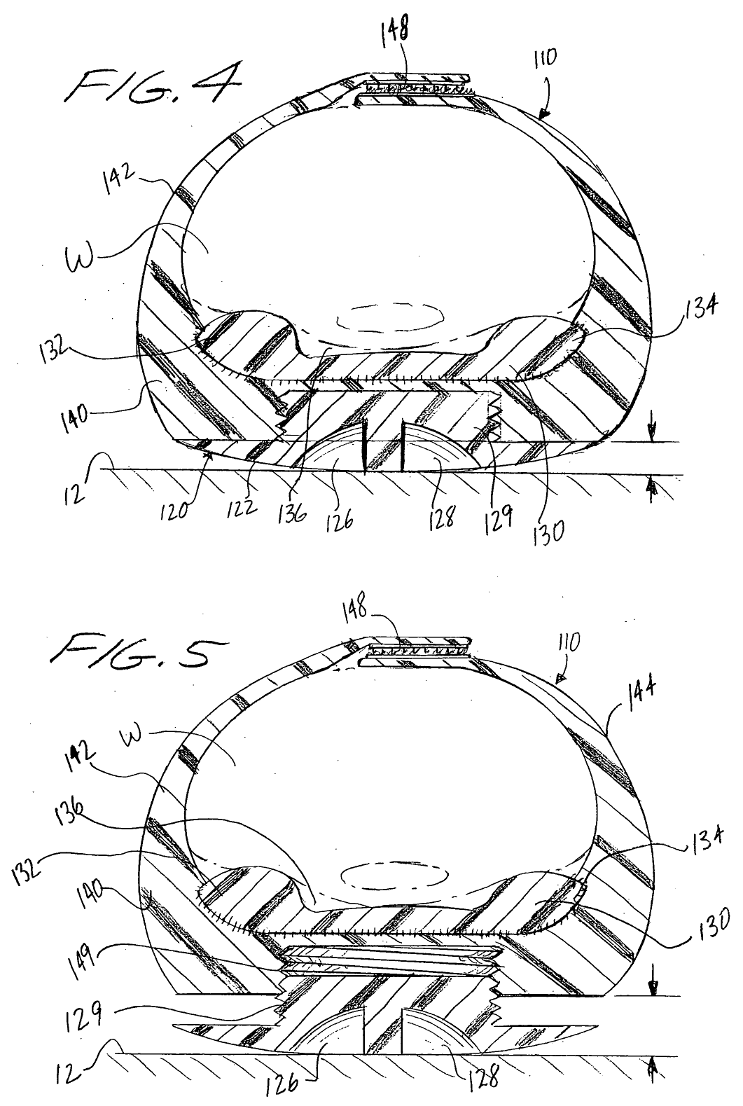

As shown in FIGS. 3B and 3C, the bottom 22 of the glide member 20 may alternatively include a plurality of individually raised or protruding bearings 24 which make contact with a surface during use of the wrist support 10, yet prevent the entire bottom surface of the glide member 20 from contacting work surface 12 upon which the wrist support 10 is used. The bearings 24 may have oval, circular or other shapes. In this embodiment, the glide member 20 may incorporate either a flat planar bottom or domed bottom 22, as desired. When utilizing a domed bottom 22, all of the bearings 24 may be raised in generally equivalent amounts or some bearings 24A, for example, at the front, back and lateral edges of the wrist support 10 may be raised somewhat more off the bottom surface 22 than the bearings 24 that are located more centrally, providing for additional stability and less rocking movement during use. Instead of, or in combination with, the bearings 24 shown in FIGS. 3B and 3C, the wrist support 10 may incorporate a system of rolling ball bearings 24B disposed in a cavity within the glide member, as shown in FIG. 3D, that are capable of rolling as the wrist moves across a surface in conjunction with the wrist support 10.

As shown in FIGS. 1, 2 and 2A, the glide member 20 is fixedly attached to the frame 40 as by an adhesive but can also be integrally molded as one unitary element, as shown in other figures described below. Optionally, the glide member 20 is selectively removable, e.g., by the use of hook and loop fasteners on opposing surfaces, allowing the user to perform other functions more easily while the frame 40 of the wrist support 10 is worn and the glide member 20 is detached.

Significantly, the wrist support 10 is not necessarily limited to use on a strictly planar surface 12 and may be used on desk containing papers and other items scattered about. Particularly, when utilizing a domed bottom 22, the wrist support 10 has the inherent ability to simply glide over these materials without greatly affecting the utility of the wrist support. In addition, while the support 10 is depicted on the left wrist W of a user, it may be utilized interchangeably on the left or right hand. Furthermore, the glide member 20 and frame 40 may optionally include magnets 51 for users who want to employ magnetic therapy during the course of use.

The wrist support 10 is fitted with and holds a comfort support 30 disposed in a cradle area 46 located at the lower portion of the frame 40 of the wrist support 10. Preferably, the comfort support 30 is firmly implanted (although not necessarily permanently set) in the cradle 46 in order to minimize movement of the comfort support 30 during use. Significantly, the comfort support 30 comprises a plurality of opposed, upstanding pillow elements 32, 34 upon which the wrist W rests. These pillow elements 32, 34 are spaced apart to provide for a gap or space 36 directly below the carpal tunnel region of the wrist W when the wrist W is appropriately propped up by the pillow elements 32, 34. When utilized properly, the presence of the gap 36 below the carpal tunnel region ensures that no pressure, or a significantly reduced amount of pressure, is placed against the wrist in that particular area. In order to ensure that the gap 36 does not completely collapse under the weight of a user's wrist, the comfort support 30 is constructed of materials that can provide the needed support yet are pliable and comfortable. Thus, the comfort support 30 may comprise conventional gel pads, specialized pads incorporating displaceable gel, foam, rubber or other soft materials.

While the side and bottom dimensions of the comfort support 30 are generally limited to the dimensions of the cradle area 46 of the frame 40 within which the comfort support 30 is disposed, the upper contour of the comfort support 30 and the pillow elements 32, 34 thereof may be varied to assume a number of shapes and degrees of thickness. Also, the comfort support 30 may be configured to have limited and designated points of contact with the wrist of a user, limiting irritation to the skin of a user.

The configuration of the comfort support 30 in connection with the gliding ability of the gliding member 20 permits the wrist support 10 to turn or rotate in conjunction with the wrist W of the user. Accordingly, the wrist support 10 provides a greater sense of stability while simultaneously allowing for an increased range of motion than conventional wrist support devices. Similarly, the result is less friction and irritation caused by the comfort region rubbing against the skin of the wrist W when the wrist W seeks to assume a more natural relaxed position.

As shown in FIGS. 1, 2 and 2A, the projections 42, 44 are formed as an integral portion of the frame 40 and serve as a means for attaching the wrist support 10 to the wrist W of a user. When the glide member 20 and frame 40 are not integrally molded, rubber or other semi-rigid, pliable materials may be used to form the frame 40 and/or projections 42, 44. As shown in FIGS. 1 and 2, the projections 42, 44 are not required to completely surround the wrist, but rather leave a gap between their ends. However the projections 42, 44 may be constructed such that they surround the entire wrist of the user or approximately 300 degrees thereof in conjunction with the area that is surrounded by the comfort support. In addition, the projections may be extended to converge with or touch one another at the top of the wrist support, or one projection may be extended while another shortened so that they converge at another location along the side of the wrist. Further, other attachment means for maintaining the wrist support in a desired location on the wrist, such as straps, elastomeric cords and the like may be utilized as well.

The projections 42, 44 are preferably formed of a material that is somewhat elastic and provides at least a minimal degree of flexibility in order accommodate a user when the device initially engages the wrist. Thus, the projections 42, 44 can be forced apart into an open or tensed position when the wrist is inserted to engage the comfort support 30, after which the projections 42, 44 assume the closed or relaxed position.

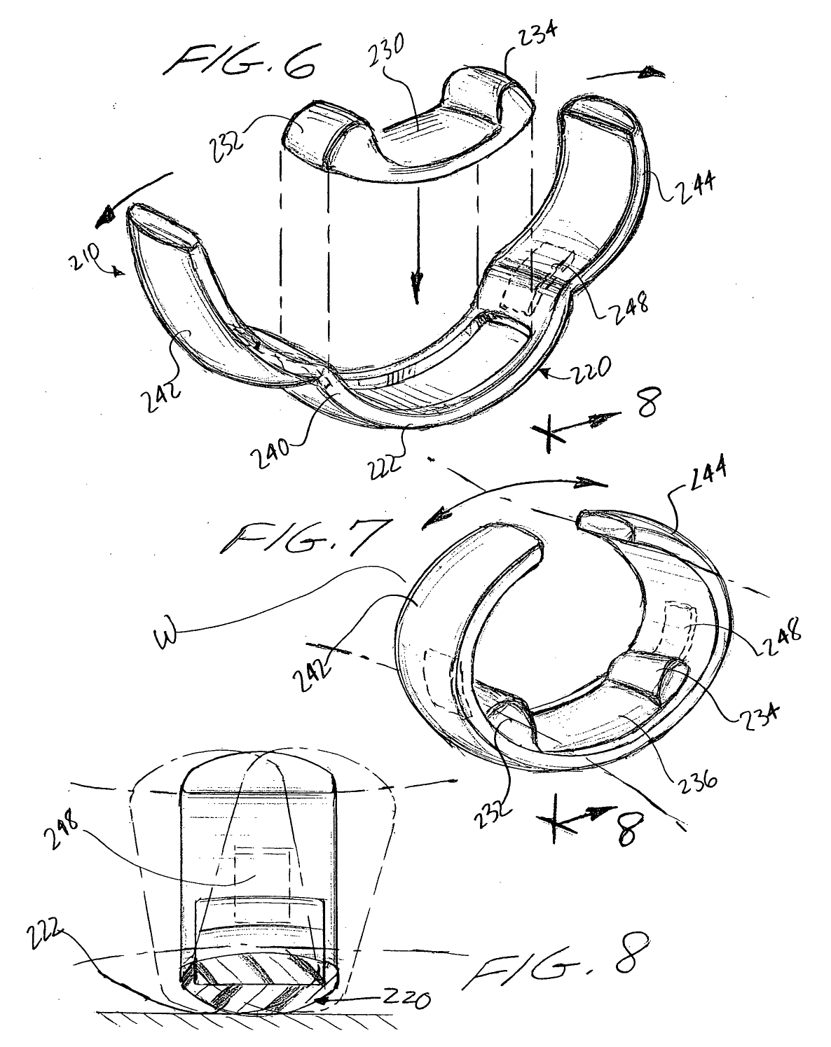

In another, second embodiment, shown in FIGS. 4 and 5, the wrist support 110 may be customized to a desired height by altering the position of the glide member 120 with respect to the frame 140. In this embodiment, the glide member 120 has a threaded tubular insertion 129 and the frame 140 incorporates a correspondingly threaded tubular cavity 149 within which the glide member 120 is rotatively positioned. The bottom surface 122 of the glide member 120 is domed but may be constructed of a flat planar surface as well. The glide member 120 further incorporates a plurality of finger inserts 126, 128 to enable selective rotation of the glide member 120 in clockwise and counterclockwise directions. Thus, when the glide member 120 is rotated to a raised position, the height of a user's wrist is raised away from the work surface proportionately. So for example, if the glide member 120 is unscrewed ¾″, a user's wrist will be propped up an additional ¾″.

The comfort support 130 is of the same general configuration as that shown in the embodiment of FIG. 1, comprising pillowed elements 132, 134 and providing for a space 136 between the comfort support 130 and the wrist of a user.

In addition, in this embodiment, the projections 142, 144 extend entirely around the wrist of a user and overlap, and are secured with a hook and loop fastener 148 at their ends. The device may also incorporate strap and quick-release mechanisms for selectively unfastening the wrist support from the wrist of a user quickly and efficiently. With such attachment means a user presses a button or squeezes a flexible insert-type fastener. When utilizing a strap and release mechanism, the projections may extend only partially around the wrist and incorporate a somewhat stiffer material to provide additional support. Other means for attaching include clips, elastomeric bands, tension bands, projections with holes to accommodate a strap or combinations of all of the foregoing discussed above.

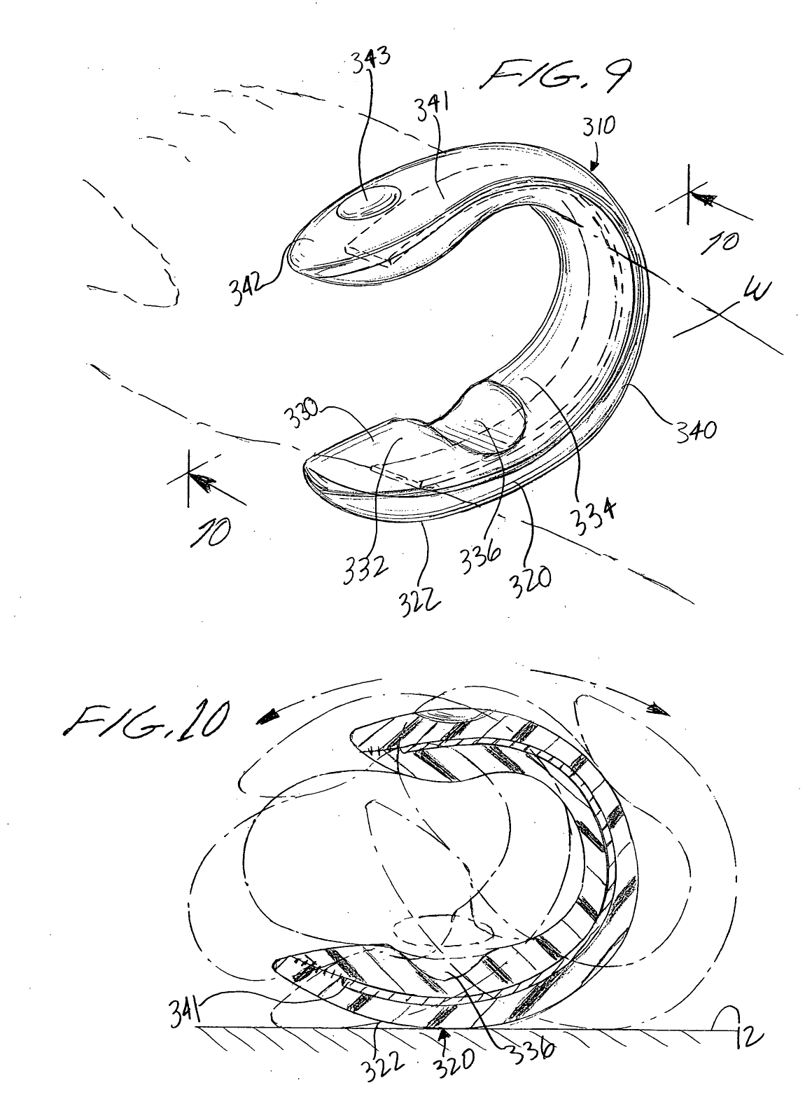

In yet another embodiment, shown in FIGS. 6, 7 and 8, the glide member 220 and frame 240 are integrally molded as a single structure. The projections 242, 244 surround a majority of the wrist when in the closed position, see FIG. 7. In the open position, see FIG. 6, the projections remain attached to the frame 240 by virtue of a pair of hinges 248. The hinges 248 that are utilized are preferably spring loaded along the hinge pin or otherwise biased toward a closed position so that after the wrist support 210 is placed on the wrist, the projections 242, 244 revert to a closed position. Alternatively, when flexible materials are used in the construction of the projections 242, 244, there is provided a flexible “living hinge” utilizing the same or similar flexible materials that are used to construct the projections 242, 244.

The comfort support 230 is of a curvilinear shape and includes pillow elements 232, 234 which provide for a gap 236 therebetween. As shown in FIG. 6, the comfort support 230 fits snugly into and is also selectively removable from the cradle 246 of the frame 240 allowing for insertion of multiple types and shapes of comfort pads as desired. Thus, users can replace a particular comfort support 230 with other comfort supports (not shown) having varying degrees of thickness, hardness, and even color type. For example, a user desiring more or less “padding” may insert a relatively thicker or thinner pad, respectively. By altering the thickness of the comfort support 230, a user can vary the height of the wrist as well—the thicker the comfort support 230 the higher the wrist will be positioned and vice versa. Also, embodiments may vary depending on the desired measurement of the gap 236 for the carpal tunnel region. Furthermore, different forms of padding or gel material may be used in the construction of a given comfort support. Thus, for example, the pillow elements may comprise displaceable gel, while other portions of the comfort support may comprise rubber. Alternatively, the pillow elements may comprise displaceable gel of a given density, while other portions of the comfort support may comprise a gel having a greater or lesser density.

As shown in FIGS. 7 and 8, the curved contour of the bottom surface 222 of the glide member 220, frame 240 and projections 242, 244, allow a user to roll the wrist laterally to the right or left with ease when the wrist support 210 is worn, limited only by the range of motion of the wrist. Likewise, as shown in FIG. 8, the wrist support 210 is also capable of forward and backward movement as it rolls along the bottom surface 222 of the glide member 220. Hence, the wrist support 210 incorporates a rocking feature, providing a greater range of motion, which allows a user to rock back and forth or side to side when a user reaches in a particular direction for an object.

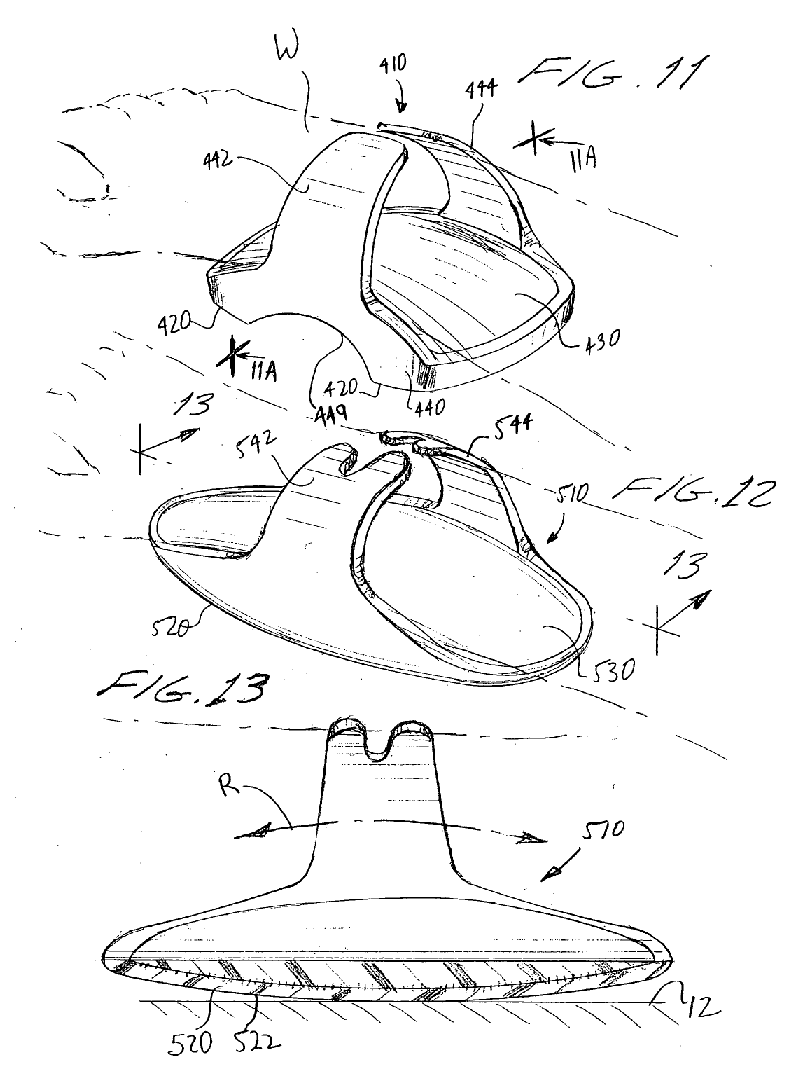

In a further and fourth embodiment of the wrist support 310, shown in FIGS. 9 and 10, the laterally-oriented frame 340 forms a single upper projection 342 that secures the wrist support 310 around the wrist W of a user. The comfort support 330 is coextensive with the entire length of the frame 340 and is attached thereto as by an adhesive. Thus, the C-shaped, laterally opening comfort support 330 is in contact with the top, side and bottom of a user's wrist rather than primarily at the bottom (and to a lesser extent on the sides of a user's wrist) as presented in other embodiments of the wrist support. Significantly, the orientation of the wrist support 310 protects the side of the wrist W while rolling outwardly as is a natural movement during relaxed periods. A depressed gap 336 is molded into the lower portion of the comfort support 330 providing for reduced pressure on the carpal tunnel region of the wrist. A depression 343 located at the top of projection 342 enables ease of positioning of the wrist support 310. In this embodiment, an interior flat wire support 341 is embedded within the frame 340, running between the ends thereof, permitting a user to mechanically manipulate the frame 340 around the wrist to a closed position and bend the frame 340 to an open position as desired. Of course, when employing a wire support, the frame 340 is constructed of material that is pliable and should still provide for reduced friction when the frame 340 and glide member 320 comprise a single structure. If different materials are used in the construction of the frame 340 and glide member 320, the bottom surface 322 of the glide member 320 may be constructed of a more resilient material so long as it provides for reduced friction. The wrist support 310 also provides for an increased range of motion from side to side and front to back as a result of the smooth and rounded edges of the frame 340 and domed surface 322 of the glide member 320.

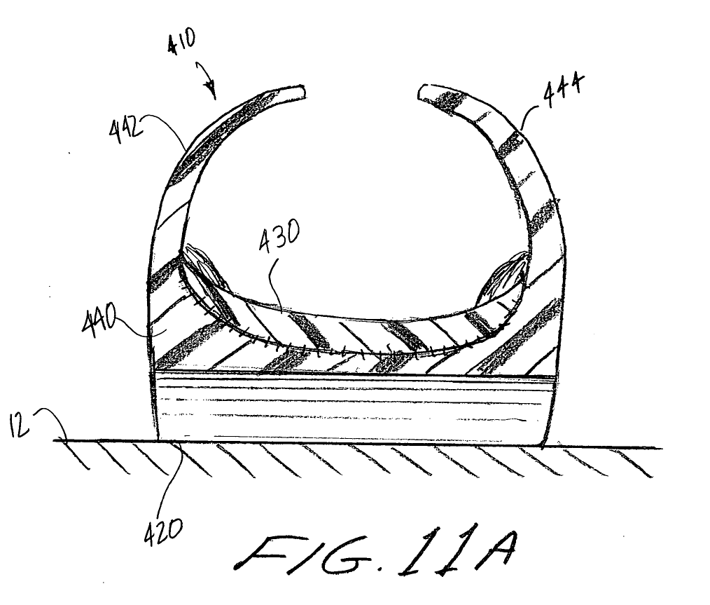

FIGS. 11, 12 and 13 depict fifth and sixth alternative embodiments of a wrist support comprising an elongated frame 440, 540 and comfort support 430, 530. In these embodiments, the comfort supports 430, 530 have a longitudinal dimension and a transverse dimension smaller than said longitudinal dimension. The configuration of the projections 442, 444, 542, 544 emanating from the frame 440, 540 permits the supports to laterally roll on the side of the projections in a uniform motion. The wrist support shown in FIG. 11 comprises an arched frame 440 culminating in two spaced glide members 420 located at the front and rear of the wrist support. Optionally, the arch can be positioned transversally culminating in two glide members located on the left and right of the wrist support. With respect to the embodiment depicted in FIG. 11, although the frame 440 forms a concave arch 449, the top surface of the comfort support 430 does not conform directly with the overall shape of the frame 440 and is preferably configured in an upward concave orientation to support and pad the wrist. In the embodiment shown in FIGS. 12 and 13, the glide member 520 comprises a dome-shaped bottom surface 522 allowing the support 510 to rock back and forth as at R, as well as to the right and left.

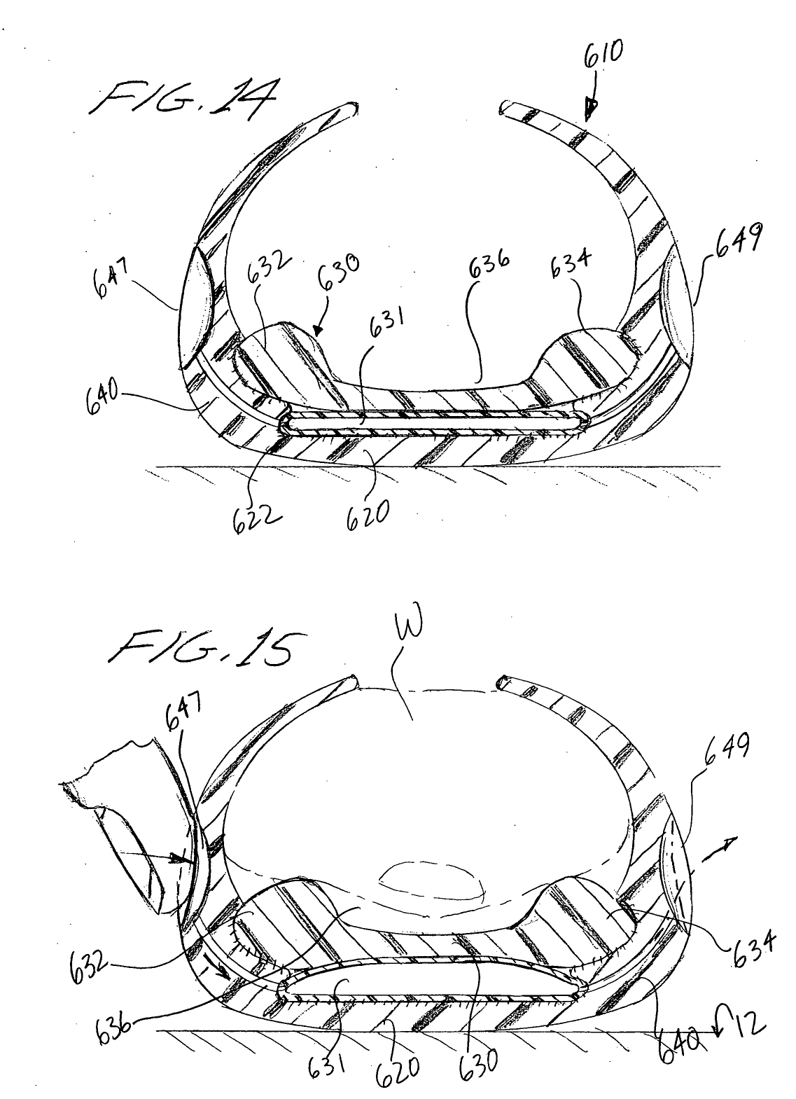

As shown in FIGS. 14 and 15, the wrist support 610 comprises a manually actuated inflatable air bladder 631 of the nature disclosed in U.S. Pat. Nos. 5,144,708 and 5,564,143 and sold by Dielectrics Industries, Inc. of Chicopee, Mass. is incorporated into the frame 640 of the wrist support 610. This feature, which can be used as an alternative or in combination with the threaded rotatable glide member 120 shown in FIGS. 4 and 5, may be incorporated into the wrist support 610, allowing for customized height adjustability as well as added comfort. The inflatable bladder 631 includes an actuator 647 for pumping air into the bladder 631 operated by finger pressure P, and a release valve 649 for releasing air. As the bladder 631 is pumped with air, the comfort support 630 is raised yet preserving the space or gap 636 between the pillowed elements 632, 634.

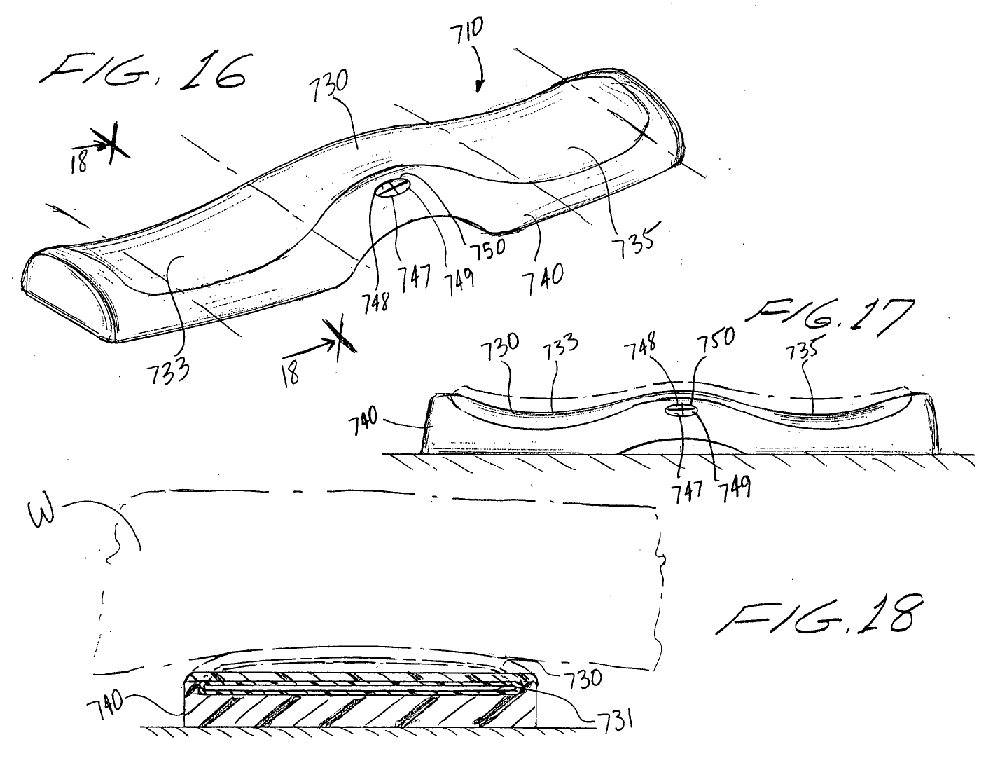

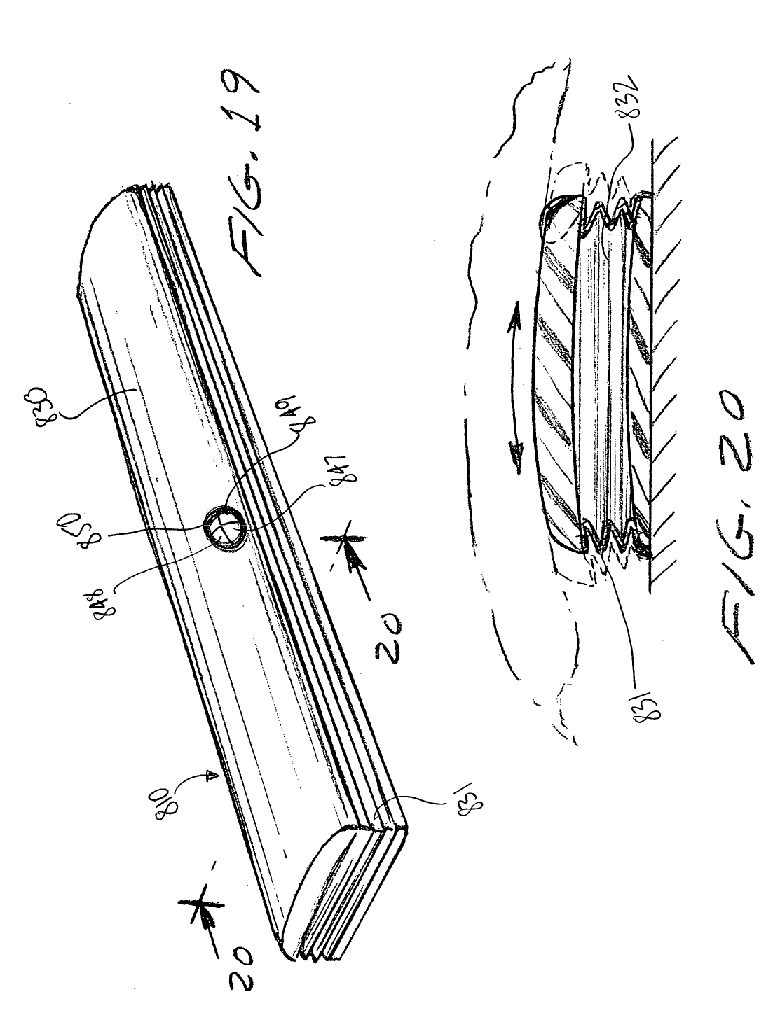

Referring to FIGS. 16, 17 and 18, there is shown another and eighth embodiment of a wrist support 710 that is intended to remain in a stationary position adjacent to other objects such as a computer keyboard (not shown). The stationary wrist support shares many of the features found in the “glidable” wrist support embodiments including, but not limited to, a comfort support 730, height adjustability and the ability to rock back and forth and side to side.

The wrist support 710 incorporates an air actuated inflatable bladder 731 as the one described above, that is adapted to suit the dimensions of the wrist support frame 740. In this embodiment, a pair of inflatable bladders 731 is located beneath a left side 733 and a right side 735, respectively, of the comfort support 730. Thus, the height of the comfort support 730 on both the left side 733 and right side 735 may be individually raised as air is pumped into the bladder 731 by pressing actuator buttons 747, 748 which each control a separate side 733, 735 of the wrist support 710. Air is continuously forced into the bladders, limited only by the capacity of the bladders that are utilized. As in other embodiments, air is individually released from the bladders by pressing buttons 749, 750 that control release valves. Using multiple air bladders within a wrist support 710 allows a degree of customization for the wrist support. Thus, a left side 733 of the support 710 may be inflated to one height and the right side 735 may be inflated to another height or not at all. Optionally, as in the other glidable embodiments, the inflatable bladder 731 may be disposed within the comfort support rather than directly beneath it.

FIGS. 19 and 20 depict another and ninth embodiment of the wrist support 810. In this embodiment, an air bladder 831 comprises a baffled chamber 832, enabling forward, rearward and side to side motion when force is applied by a user to the wrist support 810, at least when partially filled with air.

As in other embodiments, the comfort support 730, 830 comprises materials that are supportive yet soft. Preferably, the comfort support 730, 830 comprises a soft gel that displaces as the wrist rests on the surface of the comfort support 730, 830 thereby conforming to the wrist of a particular user. Other materials, such as conventional gel, foam, rubber or conventional soft, elastomeric materials may be utilized as well.

A baffle-chambered inflatable support may also incorporate a translucent “window” comprising a section of colored plastic. One end of the section of plastic is connected to the comfort support, preferably at the top thereof, while the other end of the section of plastic is connected to the frame of the wrist support. In the deflated position, the top and bottom surface of the wrist support are in contact with one another and the plastic is folded therebetween. As the device is filled with air and the top surface of the comfort support is raised, the plastic disposed between the comfort support and frame extends vertically, allowing a user to see into the interior of the support. Further, the design of the device permits the support to rock back and forth and side to side (when inflated), further adding a degree of comfort and entertainment. The presence or absence of a separate translucent window, does not preclude the baffled chamber from itself being translucent and allowing users to see into the interior of the device.

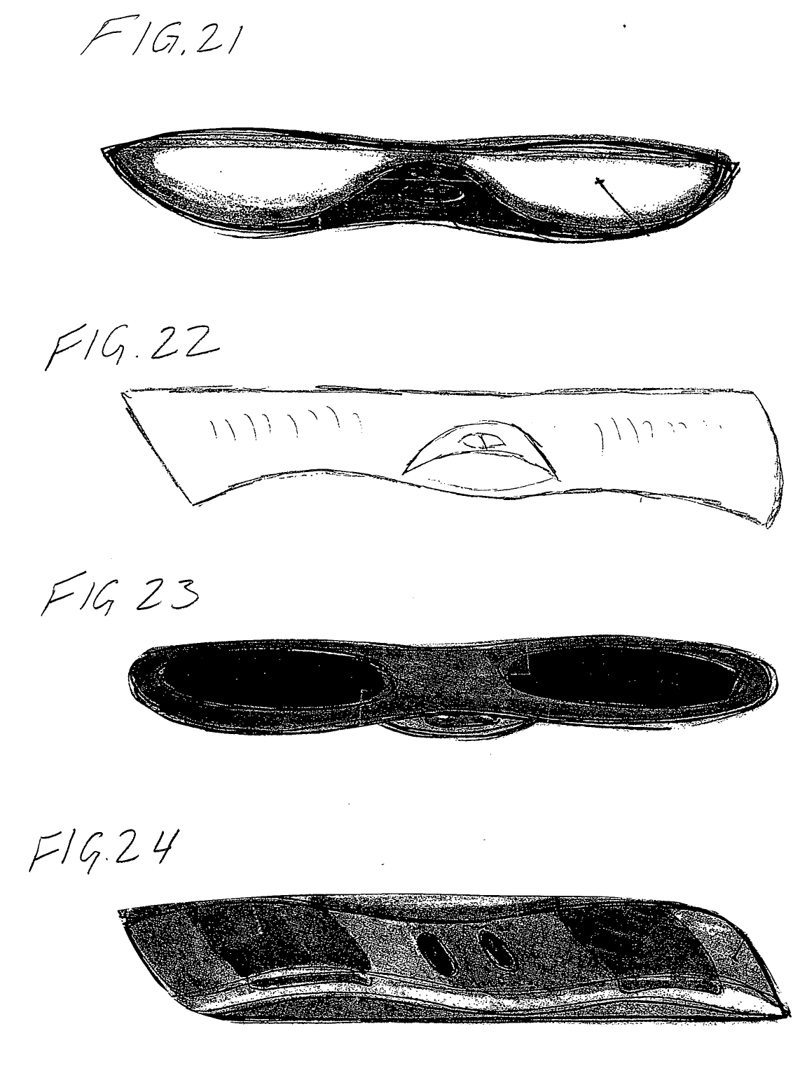

Other embodiment of a stationary support, incorporating varied placements of the comfort support and actuator and release buttons are shown in FIGS. 21 through 24. The buttons may include an enlarged metallic or plastic cap for easier use.

Although the invention is described in terms of particular embodiments, it is to be understood that the embodiments are merely illustrative of an application of the principles of the invention. Numerous modifications may be made and other arrangements may be devised without departing from the spirit and scope of the invention.

We claim:

1. A wrist support comprising:
a frame including a cradle area;
a glide member having a smooth contact surface, intended to be in contact with a work surface, the glide member being attached to a lower portion of the frame;
a soft comfort support, said comfort support being disposed in said cradle area of said frame; and
attachment means for removably attaching said wrist support to a wrist of a user.

2. The wrist support of claim 1, wherein said smooth surface of said glide member is flat.

3. The wrist support of claim 1, wherein said smooth surface of said glide member is of a dome configuration.

4. The wrist support of claim 1, said glide member comprising a plurality of bearings that contact the work surface.

5. The wrist support of claim 4, wherein said bearings are rolling bearings.

6. The wrist support of claim 1, said comfort support includes a plurality of spaced pillowed elements for supporting the wrist of a user.

7. The wrist support of claim 6, wherein said pillowed elements are located at opposite sides of the comfort support.

8. The wrist support of claim 6, wherein said pillowed elements form a space, said space located beneath a wrist of a user when said wrist support is worn.

9. The wrist support of claim 1, said attachment means comprising a plurality of spaced flexible projections emanating from said frame, said projections intended to border the wrist of a user.

10. A wrist support comprising:
a glide member having a generally smooth bottom surface with a reduced amount of friction for contacting a work surface;
a padded comfort support intended to contact a wrist of a user; and
attachment means for attaching said wrist support around a wrist of a user.

11. The wrist support of claim 10, wherein said bottom surface is dome shaped.

12. The wrist support of claim 11, said bottom surface being curved to provide unrestrained rolling movement on a work surface.

13. The wrist support of claim 10, wherein said bottom surface is flat.

14. The wrist support of claim 10, wherein said glide member is selectively removable from said attachment means.

15. The wrist support of claim 10, said glide member comprising a Teflon coated material.

16. The wrist support of claim 10, said glide member comprising polyurethane.

17. The wrist support of claim 10, said glide member comprising a hard plastic.

18. The wrist support of claim 10, further comprising a plurality of raised bearings positioned at said bottom surface.

19. The wrist support of claim 10, said comfort support comprising two raised sections to support the lateral edges of the wrist.

20. The wrist support of claim 19, wherein a gap is positioned between said raised sections wherein said gap is beneath the wrist of a user when said wrist engages said raised sections of said comfort support.

21. The wrist support of claim 10, said comfort support having a longitudinal dimension and a transverse dimension smaller than said longitudinal dimension.

22. The wrist support of claim 10, said attachment means comprising at least one projection for attaching said support around a wrist of a user.

23. The wrist support of claim 22, said projection including an interior wire support.

24. The wrist support of claim 22, said projection comprising pliable material capable of being selectively flexed around a wrist of a user.

25. The wrist support of claim 10, said attachment means comprising a plurality of projections and a hook and loop fastener.

26. A wrist support comprising:
a frame having an interior cavity;
a glide member having an insertion element correspondingly fitted to said interior cavity of said frame;
wherein said glide member is selectively extendable to a raised position in relation to said cavity to adjust the height of a wrist of a user when said wrist support is in use.

27. The wrist support of claim 26, further comprising a comfort support disposed above said interior cavity.

28. The wrist support of claim 27, said comfort support comprising raised pillow sections and a gap between said pillow sections.

29. The wrist support of claim 26, further comprising attachment means for attaching said wrist support to a wrist of a user.

30. The wrist support of claim 29, said attachment means comprising at least one flexible projection.

31. The wrist support of claim 29, said attachment means comprising a strap.

32. The wrist support of claim 29, said attachment means comprising elastomeric material.

33. The wrist support of claim 29, said attachment means comprising a hook and loop fastener.

34. The wrist support of claim 26, said glide member comprising a smooth surface.

35. The wrist support of claim 26, said glide member comprising a domed surface.

36. The wrist support of claim 26, said glide member comprising a flat surface.

37. The wrist support of claim 26, said glide member comprising a plurality of bearings.

38. The wrist support of claim 26, said glide member comprising a surface capable of rolling movement on a work surface.

39. A wrist support comprising:
a glide member;
a soft comfort support positioned above said glide member;
a selectively inflatable air bladder positioned between said glide member and said comfort support for varying the height of a wrist of a user when said bladder is pumped with air; and
attachment means for attaching said wrist support around a wrist of a user.

40. A wrist support comprising:
a frame;
a soft comfort support positioned within said frame;
a bottom surface on the frame which impedes movement of said wrist support;
a selectively inflatable air bladder positioned below said comfort support for varying the height of a wrist of a user when said bladder is pumped with air.

41. A wrist support comprising:
a glide member comprising a smooth surface;
a padded comfort support;
at least one projection for selectively attaching said support around a wrist of a user;
wherein said glide member forms a continuous contour with said projection for allowing said wrist support to freely roll on a side thereof along said projection.

42. The wrist support of claim 41, said comfort support comprising gel padding.

43. The wrist support of claim 42, said gel padding incorporating displaceable gel.

44. The wrist support of claim 41, said comfort support comprising foam.

45. The wrist support of claim 41, said comfort support comprising gel soft rubber.

46. The wrist support of claim 41, further comprising a frame wherein said comfort support is selectively removable from said frame.

47. The wrist support of claim 41, said comfort support comprising a depression disposed beneath a wrist of a user when said comfort support engages the wrist whereby a reduced amount of pressure is placed against the wrist at said depression.

48. The wrist support of claim 41, said glide member comprising a domed surface.

49. The wrist support of claim 41, said glide member comprising raised bearings.

50. The wrist support of claim 41, further comprising at least one magnet.

51. The wrist support of claim 41, said projection including an internal wire support for bending said projection around a wrist of a user.

52. The wrist support of claim 41, said projection comprising a flexible material.

53. The wrist support of claim 41, said projection including a hinge, enabling opening and closing of said projection around a wrist of a user.

54. The wrist support of claim 52, said hinge is biased in the closed position.

55. The wrist support of claim 41, said glide member comprising a Teflon coated material.

56. The wrist support of claim 41, said glide member comprising polyurethane.

57. The wrist support of claim 41, said glide member comprising a hard plastic.

58. A method of reducing repetitive stress injuries to a wrist of a user comprising the steps of:
providing a device having a glide member with a generally smooth bottom surface, a soft comfort support intended to contact a wrist of a user and attachment means for attaching said device around a wrist of a user;
attaching said device around the wrist of a user;
using said device while typing on a keyboard or utilizing a computer mouse.
